(19) United States
(12) Patent Application Publication
(10) Pub. No.: US 2005/0037815 A1
(43) Pub. Date: Feb. 17, 2005

(54) Ambient light controlled display and method of operation

(76) Inventors: Mohammad Besharat, Boynton Beach, FL (US); Faisal A. Haidar, Lake Worth, FL (US)

Correspondence Address: Randall S. Vaas;Motorola, Inc - Law Department, 600 North U.S. Highway 45, Libertyville, IL, 60048, US

(21) Appl. No.: 10/641,383

(22) Filed: Aug. 14, 2003

(51) Int. Cl. H04M 1/00; H04B 1/38

(52) U.S. Cl. 455/566

(57) ABSTRACT

A portable electronic apparatus (100) includes a ambient light sensor (112) for measuring ambient light levels, a display (106) for displaying text and icons, on a background, and a processor (304) coupled to the display (106), and the light sensor for causing indicia to be displayed on the display (106), and adjusting the color and/or size characteristics of the indicia and/or background according to the ambient light level measured through the ambient light sensor (112)

### BACKGROUND OF THE INVENTION

1. Field of the Invention

The present invention relates in general to displays. More particularly, the present invention relates to displays for portable devices.

2. Description of Related Art

Portable electronic devices that include displays such as cellular telephones, portable digital assistants (PDA), and portable game consoles are widely used. Recently, devices having larger and higher resolution displays that are capable of displaying images with higher color fidelity have been introduced. Such displays generally allow for improved user interfaces.

Such portable electronic device, are carried with their users indoors and outdoors, and operated under a wide variety of ambient light conditions. In places where the ambient light level is low, the information displayed on the display of a portable device, particular if it includes small high resolution icons, or text, may be difficult to read. One approach to increasing the readability of displays under low light conditions is to provide a display backlight. However, under intermediate light level conditions, in which the luminance of the backlight is comparable to the luminance of ambient reflected light, the effect of the backlight may be limited. Moreover, the battery drain associated with operating the backlight reduces battery life.

It would be desirable to increase the usability of portable devices that include displays under varied ambient light conditions.

### BRIEF DESCRIPTION OF THE FIGURES

The present invention will be described by way of exemplary embodiments, but not limitations, illustrated in the accompanying drawings in which like references denote similar elements, and in which:

FIG. 1 is a front view of a first embodiment of a wireless communication device;

FIG. 2 is a cross sectional side view of the wireless communication device shown in FIG. 1;

FIG. 3 is a functional block diagram of the wireless communication device shown in FIGS. 1-2;

FIG. 4 is a flow chart of a method of operating the wireless communication device shown in FIGS. 1-3;

FIG. 5 is a flow chart of a method of operating the wireless communication device shown in FIGS. 1-3;

FIG. 6 is a depiction of a display of the wireless communication device shown in FIGS. 1-3 in an alternate state; and

FIG. 7 is a flow chart of a method of operating the wireless communication device shown in FIGS. 1-3 according to another alternate embodiment.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Although the invention is described below with reference to a wireless communication device, the invention is applicable to other portable electronic devices that include displays as well. Examples of wireless communication devices to which the invention is applicable include cellular telephones, and two-way radios.

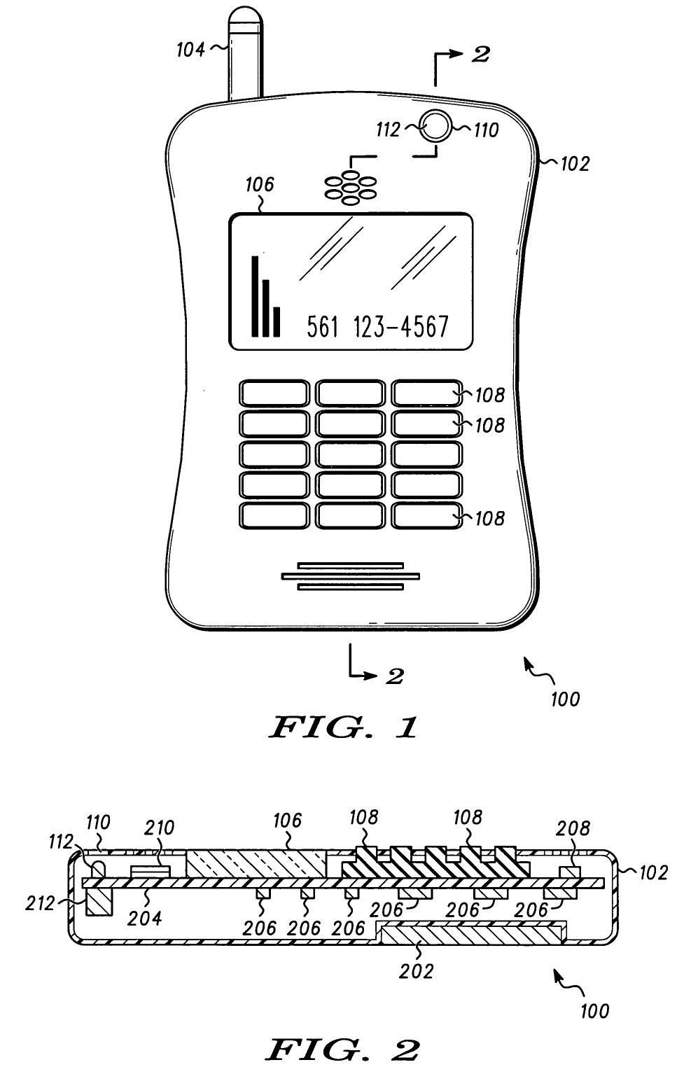

FIG. 1 is a front view of a wireless communication device 100 according to a first embodiment and FIG. 2 is a cross sectional side view of the wireless communication device shown in FIG. 1. The wireless communication device 100 comprises a housing 102 that mechanically couples and supports a plurality of components including an antenna 104, a keypad 108, and a battery 202. The housing 102 encloses a circuit board 204 that supports and electrically interconnects the keypad 108, a plurality of electrical circuit components 206 that are part of one or more electrical circuits of the wireless communication device 100, a display 106, a microphone 208, a speaker 210, and an incoming communication alert 212.

The housing 102 also includes an ambient light sensor window 110. An ambient light sensor 112 is connected to, and supported on the circuit board 204 in alignment with the light sensor window 110. The light sensor 112 is used to measure ambient light levels, and the display 106 is operated according to the ambient light level in order to optimize readability, as described below in more detail.

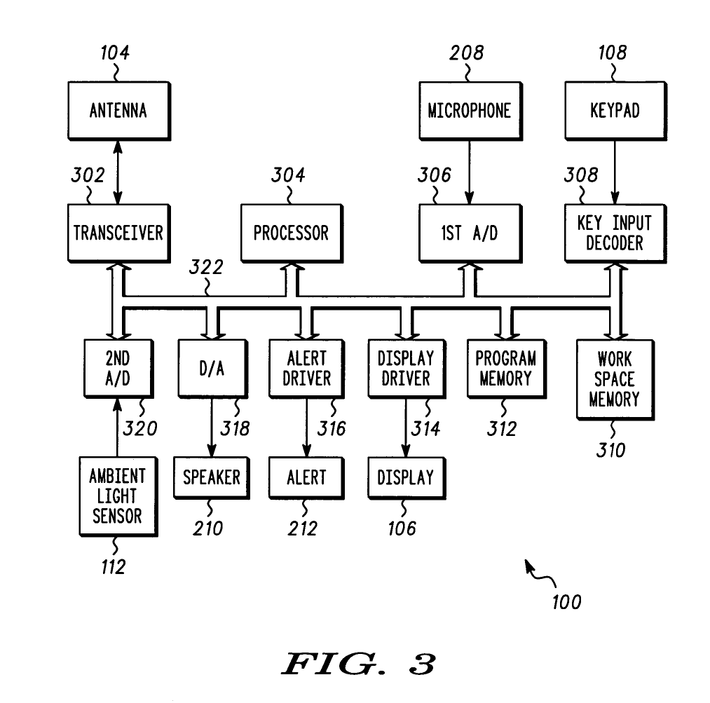

FIG. 3 is a functional block diagram of the wireless communication device 100 shown in FIGS. 1-2. As shown in FIG. 3, the wireless communication device 100 comprises a transceiver module 302, a processor 304, a first analog to digital converter (A/D) 306, a key input decoder 308, a work space memory 310, a program memory 312, a display driver 314, an alert driver 316, a digital to analog converter (D/A) 318, and second A/D 320 coupled together through a digital signal bus 322.

Those skilled in the are will recognize that the processor can be implemented using discrete logic circuitry, programmable logic unit, a microprocessor, a mcirocontroller, a digital signal processor or the like.

The transceiver module 302 is coupled to the antenna 104. Carrier signals that are modulated with data, e.g., audio data, pass between the antenna 104, and the transceiver 302.

The microphone 208 is coupled to the first A/D 306. Audio, including spoken words, is input through the microphone 208 and converted to digital format by the first A/D 306.

The keypad 108 is coupled to the key input decoder 308. The key input decoder 308 serves to identify depressed keys, and provide information identifying each depressed key to the processor 304.

The display driver 314 is coupled to the display 106. The alert driver 316 is coupled to the alert 212. The D/A 318 is coupled to the speaker 210. The D/A 312 converts decoded digital audio to analog signals and drives the speaker 210.

The ambient light sensor 112 is coupled to the second A/D 320, and through the second A/D to the processor 304. Thus, the processor 304 is able to obtain ambient light readings, and as described below the execution of programs executed by the processor 304 is conditioned on such readings.

The program memory 312 is used to store programs that control the first wireless communication device 100. The programs stored in the program memory 316 are executed by the processor 304. The program memory also stores fonts in one or more sizes, and icons in one or more sizes.

The transceiver module 302, the processor 304, the first A/D 306, the key input decoder 308, the work space memory 310, the program memory 312, the display driver 314, the alert driver 316, the D/A 318, the second A/D 320, and the digital signal bus 322, are embodied in electrical circuit components 206 shown in FIG. 2.

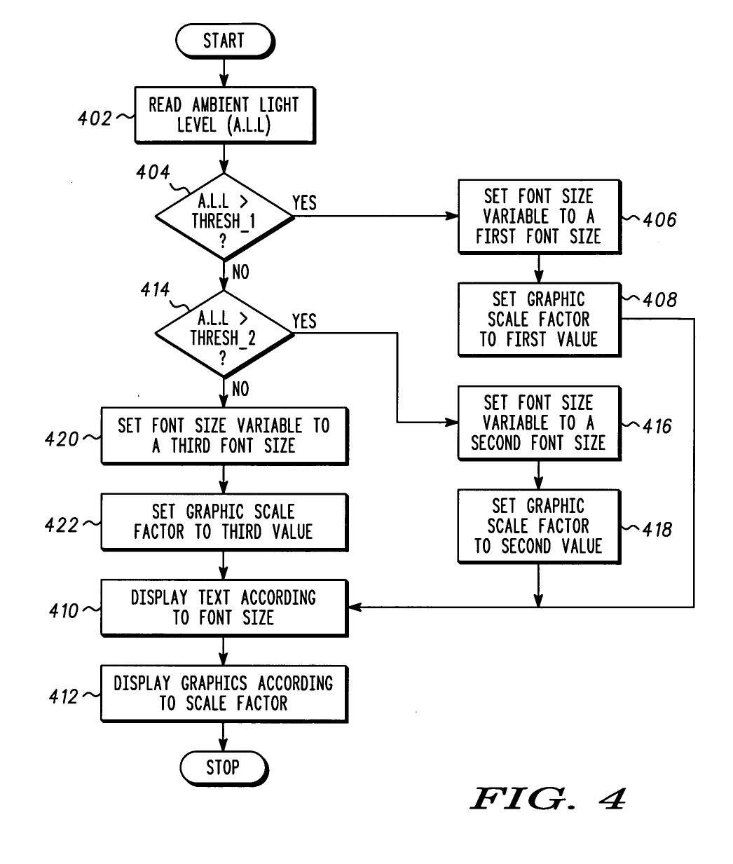

FIG. 4 is a flow chart of a method of operating the wireless communication device 100 shown in FIGS. 1-3 according to the first embodiment of the invention. A program embodying the method shown in FIG. 4 is stored in the program memory 312, and executed by the processor 304. In block 402 the ambient light level (A.L.L.) is read, e.g., by the processor 208 through the signal bus 322, and second A/D 320 from the ambient light sensor 112. Block 404 is a decision block the outcome of which depends on whether the A.L.L exceeds a first threshold value (labeled THRESH_{—}1 in FIG. 4). If so then in block 406 a font size variable that is to be used in displaying characters on the display 106 is set to a first font size, and in block 408 a scale factor, that determines the size of graphics, e.g., icons displayed on the display 106 is set to a first value. The first font size is the smallest of three font sizes that can be set by the method shown in FIG. 4. Similarly, the first value is the smallest of three values of the scale factor. Thereafter, in block 410 text is displayed on the display 106 according to the font size variable value, and in block 412 graphics e.g., icons are displayed on the display at a scale determined by the value of the scale factor.

If on the other hand it is determined in decision block 404 that the A.L.L does not exceed the first threshold, then the method continues with decision block 414, the outcome of which depends on whether the A.L.L exceeds a second threshold (labeled THRESH_{—}2 in FIG. 4). The second threshold is lower than the first threshold. If it is determined in decision block 414 that the A.L.L. exceeds the second threshold, i.e., if the A.L.L. is between the first threshold, and the second threshold, then in block 416 the font size is set to a second font size, and in block 418, the scale factor is set to a second value. The second font size is a medium font size among the three font sizes that are to be used in displaying characters on the display 106, and the second value is an intermediate value among three values of scale factor that can be set by the method shown in FIG. 4. Thereafter the method continues to blocks 410, and 412.

If on the other hand it is determined in decision block 414 that the A.L.L. does not exceed the second threshold, then in block 420 the font size variable is set a third (largest) value, and in block 422 the scale factor is set to a third (largest) value. Thereafter the method continues to blocks 410, 412.

Although the method shown in FIG. 4 can be implemented using a variety of software platforms, as an example, in a Connected Limited Device Configuration (CLDC), Mobile Information Device Profile (MIDP), Java 2 Micro Edition (J2ME) environment, the font size parameter of the setFont method can be used to set different font sizes. With regard to graphics, different size versions of graphic icons can be stored in memory and selected per FIG. 4, or the graphics can be scaled as needed.

FIG. 4 is an exemplary flow chart of a method according to a first embodiment of the invention. The invention should not be construed as limited to the particular exemplary logic flow illustrated in FIG. 4, as the logic flow, is dependent on the semantics of the programming language in which the method is implemented and the programming style of programmers implementing the method.

The method shown in FIG. 4 determines which of three ranges the A.L.L. falls. The first range is an open range having the first threshold as a lower bound, the second range is bounded by the first threshold, as the upper bound, and the second threshold as the lower bound. The third range has the second threshold as an upper bound. The method shown in FIG. 4 selects one of three font sizes, and one of three graphic, e.g., icon scaling factors based on the ambient light level. As the ambient light level falls, two successively larger font sizes, and two successively larger graphic, e.g., icon, sizes are chosen in order to facilitate reading the display 106, and reduce eye strain.

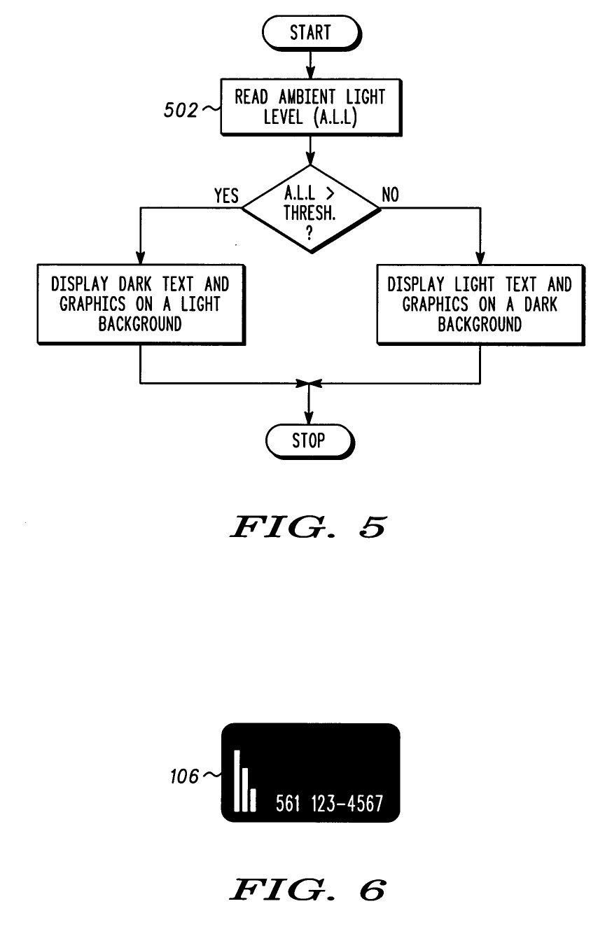

FIG. 5 is a flow chart of a method of operating the wireless communication device 100 shown in FIGS. 1-3 according to a second embodiment of the invention. A program embodying the method shown in FIG. 5 can be stored in the program memory 312, and executed by the processor 304. In block 502, the A.L.L. is read, e.g., by the processor 208 through the signal bus 322, and second A/D 320 from the ambient light sensor 112. Thereafter, in decision block 504, the A.L.L. is compared to a threshold. If it is determined in block that the A.L.L. exceeds the threshold, the method continues with block 506 in which dark text and graphics are displayed on a light background. If on the other hand it is determined in block 504 that the A.L.L. does not exceed the threshold, then in block 508 light text and graphics are displayed on a dark background.

Thus, under low light conditions the method shown in FIG. 5 displays light text and graphics on a dark background in order to improve readability, and reduce eye strain.

FIG. 6 is a depiction of the display 106 of the wireless communication device 100 shown in FIGS. 1-3 in an alternate state. As shown in FIG. 6 the display 106 is displaying a light color phone number, and a light colored signal strength indicator icon on a dark colored background. This is in contrast to the state shown in FIG. 1 in which the phone number and signal strength indicator appear in a dark color on a light background.

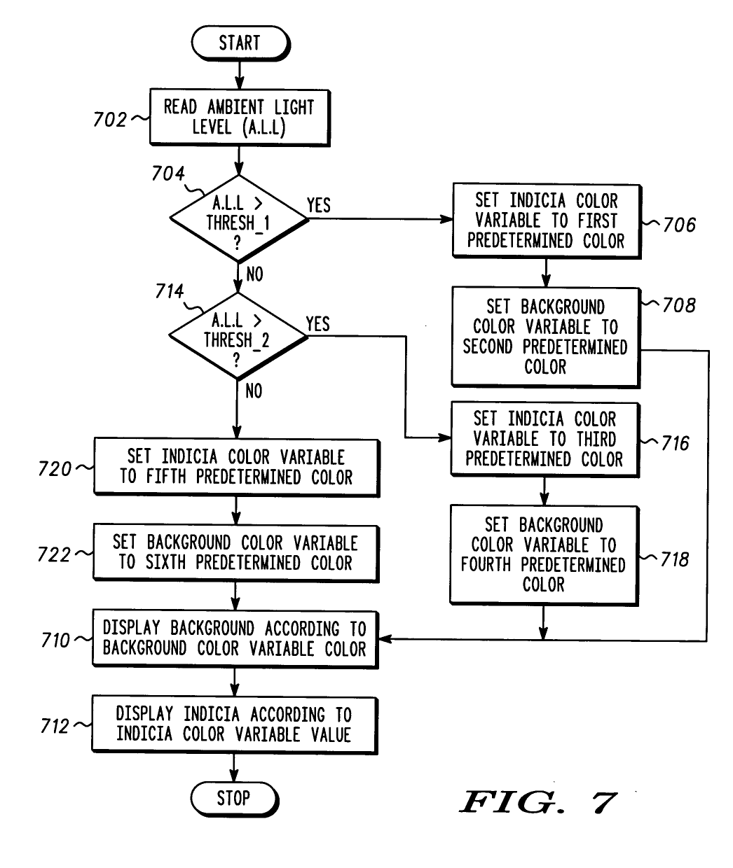

FIG. 7 is a flow chart of a method of operating the wireless communication device shown in FIGS. 1-3 according to a third embodiment of the invention. A program embodying the method shown in FIG. 7 can be stored in the program memory 312, and executed by the processor 304. In block 702 the ambient light level (A.L.L.) is read, e.g., by the processor 208 through the signal bus 322, and second A/D 320 from the ambient light sensor 112. Block 704 is a decision block the outcome of which depends on whether the A.L.L exceeds a first threshold value (labeled THRESH_{—}1 in FIG. 7). If so then in block 706 indicia color variable that determines the color of one or more indicia (e.g., icons, text) displayed on the display 106 is set to a first predetermined color, and in block 708 a background color variable, that determines the color of a background displayed on the display 106 is set to a second predetermine value. The first and second predetermined values can be chosen by experimenting with human subjects to determine colors that work well under high ambient light conditions. Thereafter, in block 710 a background is displayed on the display 106 according to the background color variable value, and in block 712 indicia e.g., icons, and text are displayed on the display in a color determined by the value of the indicia color variable.

If on the other hand it is determined in decision block 704 that the A.L.L does not exceed the first threshold, then the method continues with decision block 714, the outcome of which depends on whether the A.L.L exceeds a second threshold (labeled THRESH_{—}2 in FIG. 7). The second threshold is lower than the first threshold. If it is determined in decision block 714 that the A.L.L. exceeds the second threshold, i.e., if the A.L.L. is between the first threshold, and the second threshold, then in block 716 the indicia color variable is set to a third predetermined color, and in block 718, the background color variable is set to a fourth predetermined color. The third and fourth predetermined color values can be chosen by experimenting with human subjects to determine a colors that work well under intermediate ambient light conditions, e.g., ambient light conditions obtaining at dusk. Thereafter the method continues to blocks 710, and 712.

If on the other hand it is determined in decision block 714 that the A.L.L. does not exceed the second threshold, then in block 720 the indicia color variable is set a fifth predetermine color value, and in block 722 the background color variable is set to a sixth predetermined color value. Thereafter the method continues to blocks 710, 712. The fifth and sixth predetermined color values can be chosen by experimenting with human subjects to determine colors that work well under at low ambient light levels.

FIG. 7 shows is an exemplary flow chart of a method according to a first embodiment of the invention. The invention should not be construed as limited to the particular exemplary logic flow illustrated in FIG. 7, as the logic flow, is dependent on the semantics of the programming language in which the method is implemented and the programming style of programmers implementing the method.

The method shown in FIG. 7 determines which of three ranges the A.L.L. falls. The first range is an open range having the first threshold as a lower bound, the second range is bounded by the first threshold, as the upper bound, and the second threshold as the lower bound. The third range has the second threshold as an upper bound.

Although as shown in FIG. 7, the A.L.L. is compared to two thresholds, alternatively the A.L.L. is compared to more than two thresholds, in order to determine which of more than three ranges, the A.L.L is in, and for each range, a particular background color, and/or indicia color is set.

The method shown in FIG. 7 selects background, and indicia colors based on the ambient light level. Depending on the light level one of three predetermined indicia colors, and one of three predetermined background colors is displayed on the display.

As an example, in implementing the methods shown in FIGS. 5,7 in a Java environment such as mentioned above, the setColor methods of the Canvas class, and the Font class can be used to set the color of the background and fonts.

It is to be expected that optimum colors for the background, and indicia will vary from one display to another based on the characteristic of the display, such as whether it is reflective, or emissive, brightness, color range, however suitable values for the first through sixth predetermined color values can be determined through routine experimentation, with human subjects and a particular display, aimed at determining which colors lead to the best readability, least eye strain, and most pleasing image under different ambient light conditions. In as much as human perception is involved in the determination of color values, there is a degree of subjectivity in such a determination of predetermined color values.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

1. A portable electronic apparatus comprising:
a display;
an ambient light sensor;
a processor coupled to the display, and the ambient light sensor, wherein the processor is programmed to:
drive the display in order to display one or more indicia on the display;
measure an ambient light level via the ambient light sensor; and
adjust the size of the one or more indicia as a function of the ambient light level.

2. A portable electronic apparatus comprising:
a display;
an ambient light sensor;
a processor coupled to the display and the ambient light sensor, wherein the processor is programmed to:
measure an ambient light level; and
in the case that the ambient light level is above a predetermined threshold:
drive the display to display dark indicia on a light background; and
in the case that the light level is below the predetermined threshold: drive the display to display light indicia on a dark background.

3. A portable electronic apparatus comprising:
a display;
an ambient light sensor;
a processor coupled to the display and the ambient light, wherein the processor is programmed to:
measure an ambient light level using the ambient light sensor; and
adjust a color of one or more indicia displayed on the display in response to the ambient light level.

4. The portable electronic apparatus according to claim 3 wherein:
the processor is programmed to compare the ambient light level to one or more ambient light level range limits in order to determine an ambient light level range that the ambient light level is in, and adjust the color of the one more indicia to a color associated with the ambient light level range.

5. A method of operating a portable electronic device that is equipped with a display and a light sensor, the method comprising:
sensing an ambient light level using the light sensor; and
adjusting one or more colors of objects displayed on the display in response to the ambient light level.

6. The method according to claim 5 wherein adjusting one or more colors of objects displayed on the display in response to the ambient light level, comprises:
adjusting a color of a background displayed on the display.

7. The method according to claim 5 wherein adjusting one or more colors of objects displayed on the display in response to the ambient light level, comprises:
adjusting a color of at least a portion of an indicia displayed on the display.

8. The method according to claim 7 wherein adjusting a color of at least a portion of an indicia displayed on the display, comprises:
adjusting a color of text displayed on the display.

9. The method according to claim 7 wherein adjusting a color of at least a portion of an indicia displayed on the display, comprises:
adjusting a color of at least a portion of an icon displayed on the display.
